(19) United States
(12) Patent Application Publication
(10) Pub. No.: US 2006/0140231 A1
(43) Pub. Date: Jun. 29, 2006

(54) Method of controlling output of laser diode and output control device of laser diode having function of charging control parameter

(75) Inventor: Suk-gyun Han, Bundang-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/318,606

(22) Filed: Dec. 28, 2005

(30) Foreign Application Priority Data
Dec. 29, 2004 (KR) 10-2004-0115033

(51) Int. Cl. H01S 3/13; H01S 3/00

(52) U.S. Cl. 372/29.02; 372/38.01

(57) ABSTRACT

A method of controlling an output of a laser diode and an output control device of a laser diode having a function of changing the control parameter are provided. The method includes setting an output auto-control section of a laser diode, sampling a digital output voltage of the laser diode during the output auto-control section, calculating a difference between a maximum value and a minimum value of the sampled digital output voltage, and selecting a new control parameter when the difference is larger than a reference value. A control parameter used in an output control device of a laser diode is automatically set corresponding to a characteristics of each laser diode, such that it is possible to prevent a phenomenon in which an optical power level is fluctuated when the control parameter set according to a single characteristic of the laser diode is improper due to a fixed control parameter in a conventional optical power control device.

### CROSS-REFERENCE TO RELATED PATENT APPLICATION

This application claims the benefit of Korean Patent Application No. 10-2004-0115033, filed on Dec. 29, 2004, in the Korean Intellectual Property Office, the entire disclosure of which is hereby incorporated by reference.

### BACKGROUND OF THE INVENTION

1. Field of the Invention

The present invention relates to an output control device of a laser diode. More particularly, the present invention relates to a method of changing a control parameter of an output control device of a laser diode and an output control device of a laser diode having a function of changing the control parameter.

2. Description of the Related Art

FIG. 1 is a block diagram illustrating a construction of an output control device of a conventional laser diode. The output control device of the laser diode comprises an analog/digital converter 100 to which a current representing an optical power of the laser diode is input. An error voltage generator 110 generates an error voltage corresponding to a difference between a reference voltage and an output voltage of the laser diode. A proportional integral controller 120 generates a control voltage by proportionally integrating the error voltage. A digital/analog converter 130 converts the proportionally integrated control voltage and inputs it to the laser diode.

In the output control device of the conventional laser diode, values of a proportional constant (Kp) and an integral constant (Ki) of the controller are selected through experiment and are stored in the proportional integral controller, and these values are not changed during the output control. Although laser diodes have the same specification, characteristics of laser diodes are slightly different depending on manufacturers, production numbers and other factors. Thus, the value of parameters selected by the controller are not proper due to the deviation of the laser diodes from the characteristics deviation. As a result, a phenomenon occurs in which the output voltage of the laser diode is not constant.

FIG. 2 illustrates an output voltage waveform of the laser diode in a case of an image quality being inferior. FIG. 3 is a view illustrating an output voltage waveform of the laser diode in a case of an image quality being normal. In FIG. 2, reference numeral 200 designates an input voltage of the laser diode which has passed through a digital/analog converter, and reference numeral 210 designates an output voltage of the laser diode which has passed through an analog/digital converter. In FIG. 3, reference numeral 300 designates an input voltage to the laser diode which has passed through the digital/analog converter, and reference numeral 310 designates an output voltage from the laser diode which has passed through the analog/digital converter.

As shown in FIG. 2, when a deviation-width of the output voltage 210 from the diode with respect to the input voltage 200 to the normal laser diode increases depending upon a characteristic of the laser diode, an intensity of optical power varies, whereby an irregularity in brightness is generated on printed images. However, in the case shown in FIG. 3, the deviation-width of the output voltage 310 from the diode with respect to the input voltage 200 to the normal laser diode is negligible, whereby inferior images are not generated.

Accordingly, there is a need for a control device which can change a control parameter depending on the difference in characteristics of a laser diode.

### SUMMARY OF THE INVENTION

Exemplary embodiments of the present invention provide a method of controlling the output of a laser diode and an output control device of a laser diode having a function of changing a control parameter, in which a suitable control parameter is automatically set corresponding to characteristics of each laser diode in order to prevent a phenomenon in which an optical power level is fluctuated when the control parameter set according to a single characteristic of the laser diode is improper due to a fixed control parameter in a conventional optical power control device, thus removing the cause of inferior quality.

According to an exemplary embodiment of the present invention, a method of controlling output of a laser diode comprises setting an output auto-control section of a laser diode, sampling a digital output voltage of the laser diode during the output auto-control section, calculating a difference between a maximum value and a minimum value of the sampled digital output voltage, and selecting a new control parameter when the difference is larger than a reference value.

The method may further comprise using a previous control parameter when the difference is smaller than the reference value.

According to another exemplary embodiment of the present invention, a method of controlling output of a laser diode comprises setting an output auto-control section of a laser diode, sampling a digital output voltage of the laser diode during the output auto-control section, calculating a difference between a maximum value and a minimum value of the sampled digital output voltage, selecting a new control parameter when the difference is larger than a reference value, generating an error voltage between the output voltage of the laser diode sampled during the output auto-control section and the reference voltage, and generating a corrected control voltage by proportionally integrating the error voltage using a control parameter, and applying the control voltage to the laser diode.

The setting the output auto-control section may further comprise converting the output voltage of the laser diode, and the applying the control voltage to the laser diode may further comprise converting the control voltage.

According to an exemplary embodiment of the present invention, an output auto-control device of a laser diode comprises an analog/digital converter for converting an output voltage of the laser diode into a digital type. A sampling unit samples a digital output voltage supplied from the analog/digital converter during an output auto-control section. A calculator calculates a difference between a maximum value and a minimum value of the sampled digital output voltage. A control parameter selecting unit selects a new control parameter when the difference is larger than a reference value. An error voltage generator generates an error voltage between the sampled digital output voltage and the reference voltage, and a control voltage generator generates a corrected control voltage by proportionally integrating the error voltage supplied from the error voltage generator using a control parameter.

The control voltage generator preferably includes a proportional integral processing unit for generating a corrected control voltage by proportionally integrating the error voltage supplied from the error voltage generator using a constant proportional constant and a constant integral constant, and a digital/analog converter for converting the corrected control voltage into an analog type and applying the converted control voltage to the laser diode.

### BRIEF DESCRIPTION OF THE DRAWINGS

The above and other features and advantages of exemplary embodiments of the present invention will become more apparent from the following detailed description with reference to the attached drawings in which:

FIG. 1 is a block diagram illustrating a construction of an output control device of a conventional laser diode;

FIG. 2 is a view illustrating an output voltage waveform of the laser diode in a case of an image quality being inferior;

FIG. 3 is a view illustrating an output voltage waveform of the laser diode in a case of an image quality being normal;

FIG. 4 is a block diagram illustrating a construction of an output control device of a laser diode which has a function of changing a control parameter according to an embodiment of the present invention;

FIG. 5 is a graph illustrating a relationship between an error voltage and a proportional constant among the control parameters, in which thirty laser diodes are randomly selected;

FIG. 6 is a graph illustrating a relationship between the error voltage and the proportional constant obtained through a regression analysis;

FIG. 7 is a block diagram illustrating in detail the construction of a control voltage generator shown in FIG. 4; and

FIG. 8 is a flowchart illustrating a method of changing the control parameter of the laser diode according to an embodiment of the present invention.

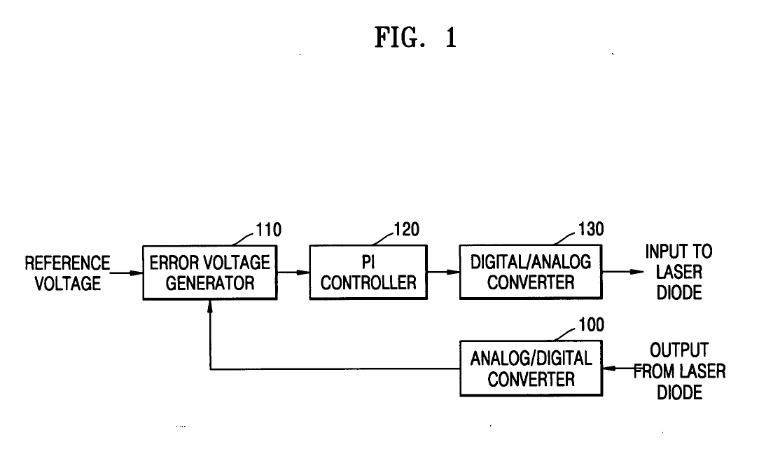

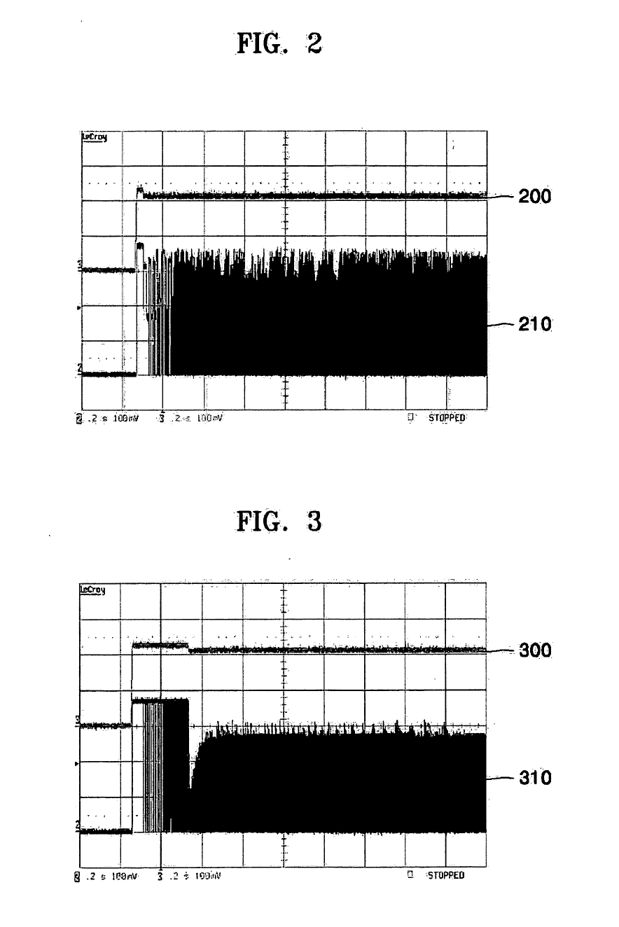

Throughout the drawings, like reference numbers will be understood to refer to like elements, features and structures.

### DETAILED DESCRIPTION OF EXEMPLARY EMBODIMENTS

Hereinafter, a method of controlling the output of a laser diode and an output control device of a laser diode which has a function of changing a control parameter according to exemplary embodiments of the present invention will be described in detail with reference to attached drawings.

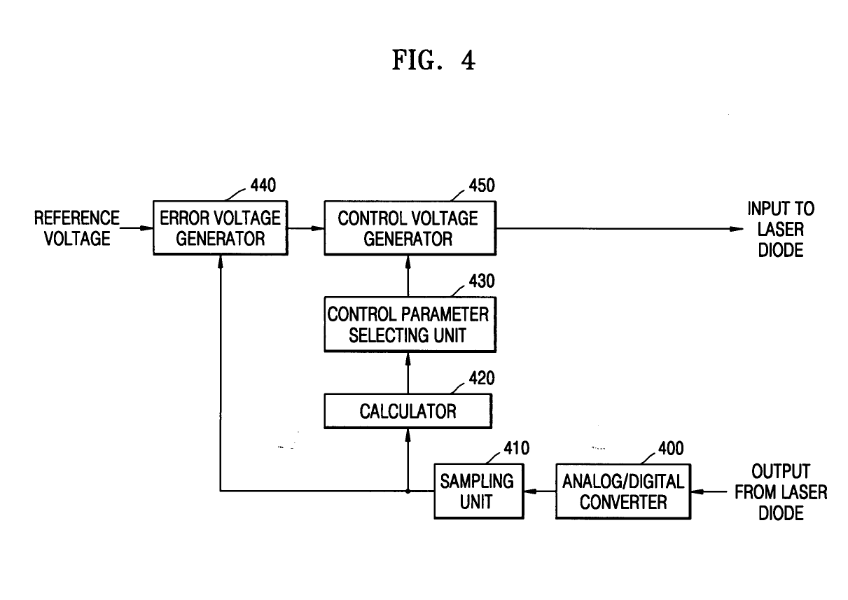

FIG. 4 is a block diagram illustrating a construction of the output control device of the laser diode which has a function of changing a control parameter according to an exemplary embodiment of the present invention. The output control device of the laser diode, which has a function of changing a control parameter, includes an analog/digital converter 400, a sampling unit 410, a calculator 420, a control parameter selecting unit 430, an error voltage generator 440, and a control voltage generator 450.

The analog/digital converter 400 converts an output voltage of the laser diode into a digital value.

The sampling unit 410 samples the digital output voltage of laser diode output from the analog/digital converter 400 during an output auto-control section which is in advance set. According to an exemplary embodiment, the output auto-control section may be set in the sampling unit 410, and the analog/digital converter 400 may be controlled such that the converting operation is performed in the analog/digital converter 400 only during the output auto-control section. Further, it is possible to set the number of times the sampling is done during the output auto-control section in the sampling unit 410. In this case, the digital output voltage supplied from the analog/digital converter 400 is sampled as many times as the sampling is done and then it is supplied to the next stage.

The calculator 420 calculates the difference between maximum values and the minimum value among the sampled digital output voltages. When the difference between maximum value and the minimum value, that is, the digital output voltage deviation is smaller than a reference value, the previous control parameter is used. However, if the digital output voltage deviation is larger than the reference value, it can be noted that the previous control parameter cannot generate an effective control voltage. Therefore, a new control parameter for generating the effective control voltage needs to be established.

The control parameter selection unit 430 selects a new control parameter, when the digital output voltage deviation of the laser diode is larger than the reference value. According to an exemplary embodiment, when the digital output voltage deviation is 0.5V or less, the previously-set control parameter is used. When the digital output voltage deviation is 0.5V or more, the selecting unit 530 selects a new control parameter and uses it for the next printing.

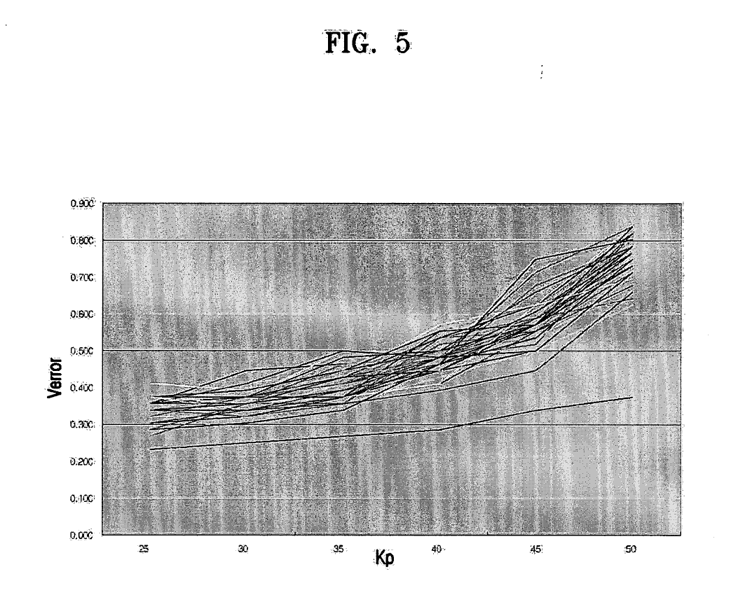

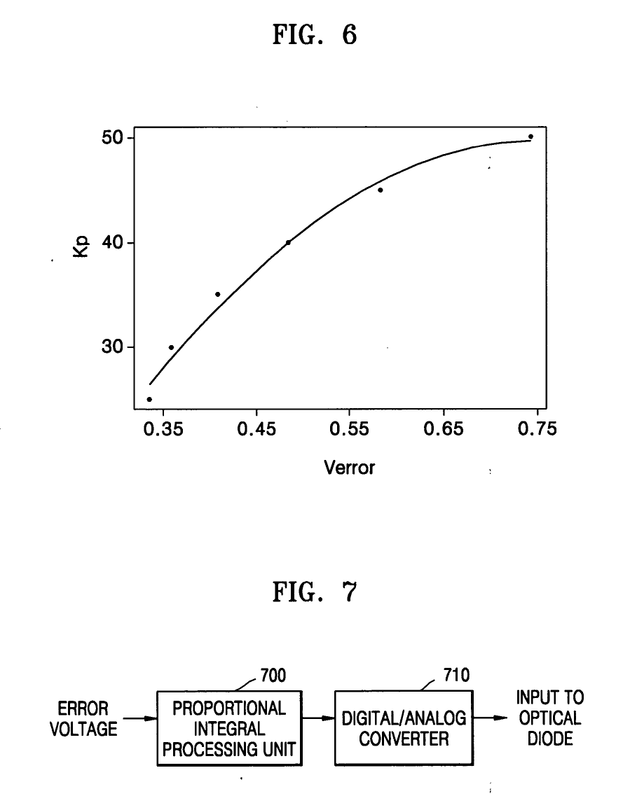

FIG. 5 a graph illustrating a relationship between the digital output voltage deviation (Verror) and a proportional constant among the control parameters, in which thirty laser diodes are randomly selected. FIG. 6 is a graph illustrating a relationship between the voltage variation (Verror) and the proportional constant obtained through a regression analysis.

When the regression analysis is performed using the thirty graphs shown in FIG. 5 as representative values, the relationship expression between the proportional constant (Kp) and the voltage deviation (Verror) as shown in FIG. 6 is obtained.

Specifically, the following equation is obtained.
Kp−25.35+199.05Verror−131.9Verror²

When the deviation voltage is input to the above described equation, a new proportional constant (Kp) is obtained. For example, assuming that the Verror is 0.55 V, the value of Kp is about 44 and this value is stored as a new control parameter. Even though the new control parameter is used, if the Verror is larger than 0.5V, a new proportional constant (Kp) is obtained using the above-described equation.

The error voltage generator 440 generates an error voltage between the output voltage of the laser diode which is sampled during the output auto-control section set in a predetermined period and the reference voltage.

The control voltage generator 450 proportionally integrates the error voltage supplied from the error voltage generator 440 by the use of the previous control parameter or a new control parameter to generate a corrected control voltage and applies it to the laser diode.

FIG. 7 is a block diagram illustrating a detailed construction of the control voltage generator 450. The control voltage generator 450 includes a proportional integral processing unit 700 and a digital/analog converter 710.

A proportional unit (not shown) of the proportional integral processing unit 700 multiplies a proportional constant (Kp) and an error voltage supplied from the error voltage generator 440 to generate a proportional term. An integral unit (not shown) accumulates the error voltage and multiplies an integral constant (Ki) to generate an integral term. An adder (not shown) adds the proportional term and the integral term and outputs their sum. At first, the proportional constant (Kp) and the integral constant (Ki) are set to optimal values obtained from real control results using a cut and try scheme. However, when the voltage deviation (Verror) is larger than the reference value, the proportional constant (Kp) selected at the control parameter selecting unit 430 is used. The previous integral constant is used as the integral constant (Ki). On the other hand, a negative number during a subtraction process of the error voltage generator 440 may be generated. In this case, the proportional integral processing unit 700 can simplify the proportional process and the integral process by adding one sign bit to an output of the error voltage generator 440.

The digital/analog converter 710 converts the control voltage supplied from the proportional into an analog type and supplies it to the laser diode.

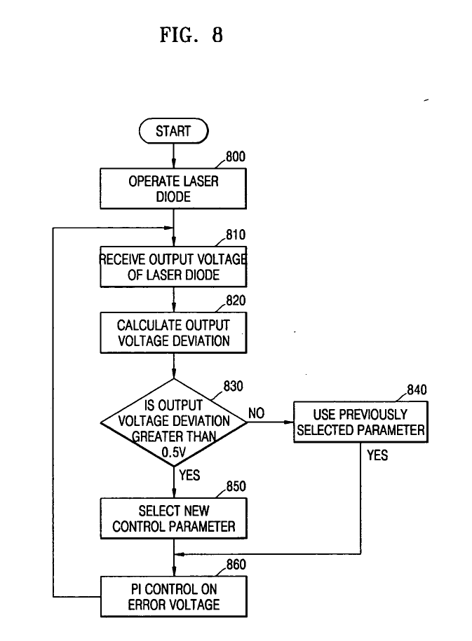

FIG. 8 is a flowchart illustrating a method of changing the control parameter of the laser diode according to an exemplary embodiment of the present invention. The method of changing the control parameter of the laser diode according to an embodiment of the present invention will be described with reference to FIGS. 4 and 7.

When a voltage is applied to the laser diode and light is emitted from the laser diode (operation 800), a light receiving unit (not shown) of the laser diode receives the light and generates a current. An amount of this current is proportional to an intensity of optical power. The current is converted into a voltage by using a fixed resistor R, and the converted voltage corresponds to a value which is obtained by converting the intensity of the optical power into a voltage. At this time, the output voltage is converted into a binary number at the analog/digital converter 400 to allow it to be input to a digital controller.

The calculator 420 calculates a deviation of the output voltage converted at the analog/digital converter 400 during the time of printing a piece of paper (operation 820), and determines whether the deviation of the output voltage is larger than a predetermined reference value (operation 830). According to an exemplary embodiment, the calculator 420 determines whether the deviation of the output voltage is larger than 0.5 V. Of course, those of ordinary skill in the art will readily appreciate that any suitable value could be used. As a result of the determination, when the voltage deviation is not larger than the predetermined reference value, the previously selected parameter is used (operation 840).

When the voltage deviation is larger than the predetermined reference value, the control parameter selecting unit 430 selects a new control parameter (operation 850).

On the other hand, when the analog/digital converter 400 converts the output voltage of the laser diode, an error voltage between the reference voltage and a digital output voltage sampled at the sampling unit 410 is generated (operation 860).

The error voltage generated the step 860 is proportionally integrated by using a control parameter and generates a corrected control voltage (operation 870). At this time, the proportional integral processing unit 700 performs a proportional integral process by using a newly calculated proportional constant (Kp) when the voltage deviation is larger than a predetermined reference value. A proportional integral equation is as follows.
U=Kp×E+Ki×∫Edt

Here, U is a corrected control voltage, E is an error voltage, and Ki is an integral constant.

The corrected control voltage which has undergone the proportional integral process is input again to the laser diode and the operations 810 to 870 are repeated until it is stabilized.

Exemplary embodiments of the present invention can be written as computer programs and can be implemented in general-use digital computers that execute the programs using a computer readable recording medium. Examples of the computer readable recording media include magnetic storage media (such as, ROM, floppy disks, hard disks, and the like), optical recording media (such as, CD-ROMs, or DVDs), and storage media such as carrier waves (such as, transmission through the Internet).

As described above, according to exemplary embodiments of the present invention, a control parameter used to an output control device of a laser diode is automatically set corresponding to a characteristics of each laser diode, such that it is possible to prevent a phenomenon in which an optical power level is fluctuated when the control parameter set according to a single characteristic of the laser diode is improper due to a fixed control parameter in a conventional optical power control device and to remove the cause of inferior quality.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling an output of a laser diode, the method comprising:
setting an output auto-control section of a laser diode;
sampling a digital output voltage of the laser diode during the output auto-control section;
calculating a difference between a maximum value and a minimum value of the sampled digital output voltage; and
selecting a new control parameter when the difference is larger than a reference value.

2. The method of controlling output of the laser diode of claim 1, further comprising using a previous control parameter when the difference is smaller than the reference value.

3. A method of controlling output of a laser diode, the method comprising:
setting an output auto-control section of a laser diode;
sampling a digital output voltage of the laser diode during the output auto-control section;
calculating a difference between a maximum value and a minimum value of the sampled digital output voltage;
selecting a new control parameter when the difference is larger than a reference value;
generating an error voltage between the output voltage of the laser diode sampled during the output auto-control section and the reference voltage; and
generating a corrected control voltage by proportionally integrating the error voltage using a control parameter and applying the control voltage to the laser diode.

4. The method of controlling output of the laser diode of claim 3, further comprising using a previous control parameter when the difference is larger than the reference value.

5. The method of controlling output of the laser diode of claim 3, wherein the setting the output auto-control section further comprises converting the output voltage of the laser diode to a digital value; and
wherein the applying step further comprises converting the control voltage to an analog value.

6. The method of controlling output of the laser diode of claim 4, wherein the step of setting an output auto-control section further comprises converting the output voltage of the laser diode to a digital value; and
wherein the applying step further comprises converting the control voltage to an analog value.

7. A computer readable recording medium in which a program for implementing the method of claim 1 is recorded.

8. A computer readable recording medium in which a program for implementing the method of claim 3 is recorded.

9. An output auto-control device of a laser diode, the device comprising:
an analog/digital converter for converting an output voltage of the laser diode into a digital type;
a sampling unit for sampling a digital output voltage supplied from the analog/digital converter during an output auto-control section;
a calculator for calculating a difference between a maximum value and a minimum value of the sampled digital output voltage;
a control parameter selecting unit for selecting a new control parameter when the difference is larger than a reference value;
an error voltage generator for generating an error voltage between the sampled digital output voltage and the reference voltage; and
a control voltage generator for generating a corrected control voltage by proportionally integrating the error voltage supplied from the error voltage generator using a control parameter.

10. The output auto-control device of the laser diode of claim 9, wherein the control voltage generator includes a proportional integral processing unit for generating a corrected control voltage by proportionally integrating the error voltage supplied from the error voltage generator using a constant proportional constant and a constant integral constant; and
a digital/analog converter for converting the corrected control voltage into an analog type and applying the converted control voltage to the laser diode.

11. The output auto-control device of the laser diode of claim 9, wherein the control parameter selector uses a previous control parameter when the difference is less than the reference value.

12. The output auto-control device of the laser diode of claim 10, wherein the control parameter selector uses a previous control parameter when the difference is less than the reference value.
